(19) United States
(12) Patent Application Publication
(10) Pub. No.: US 2009/0240687 A1
(43) Pub. Date: Sep. 24, 2009

(54) Method of Processing a Collection of Document Sources

(76) Inventor: Thomas Eskebaek, Copenhagen (DK)

Correspondence Address: HARNESS, DICKEY & PIERCE, P.L.C., P.O. BOX 8910, RESTON, VA, 20195, US

(21) Appl. No.: 12/309,601

(22) PCT Filed: Jul. 20, 2007
(86) PCT No.: PCT/EP2007/057537

§ 371 Date: Mar. 17, 2009

(30) Foreign Application Priority Data
Jul. 27, 2006 (DK) PA 2006 01019
Oct. 26, 2006 (DK) PA 2006 01389
Mar. 28, 2007 (DK) PA 2007 00478

(51) Int. Cl. G06F 17/30

(52) U.S. Cl. 707/5; 707/100; 707/E17.008; 707/6

(57) ABSTRACT

In a method of processing a collection of a number of document sources in a computer system to retrieve a number of relevant substrings from the document sources, each relevant substring has relevance with respect to at least one set of selection parameters. The method includes splitting each document source of the collection of document sources into a plurality of source substrings, whereby each source substring comprises at least two concepts, the plurality of source substrings including at least the relevant substrings. The source substrings are stored, and the relevant substrings are uniquely identified among the source substrings. Representations of the sets of relevant substrings may be displayed in a matrix. The sets of selection parameters may be augmented with further selection parameters derived from concepts from a predefined concept hierarchy.

The present application claims priority from Danish patent application Nos. PA 2006 01019 filed on 27 Jul. 2006, PA 2006 01389 filed on 26 Oct. 2006, and PA 2007 00478 filed on 28 Mar. 2007, the entire disclosures and claims of which are hereby incorporated by reference.

### TECHNICAL FIELD

The present invention relates to a method applicable in post-retrieval processing of document sources, and more specifically to a method of processing a collection of a number of document sources in a computer system to retrieve a number of relevant substrings from said document sources.

### BACKGROUND OF THE INVENTION

While modern search and information retrieval systems are becoming increasingly more efficient, a major problem remains in the processing of the retrieved documents. Today the post-retrieval processing of documents is done manually, i.e. a person reads through each of the retrieved documents and highlights or copies the relevant passages and paragraphs. The process is very time consuming, error prone, and severely limits the scope of materials processed.

The available prior art systems can be roughly divided into three groups: search systems, summarization systems, and knowledge mining and extraction systems.

Prior art within the group of search systems includes a number of methods and systems focused on information retrieval, i.e. on identifying relevant documents in a large collection of documents. In general, these systems indexes the documents it must search through, compiling a list of words and relating them to the documents. Given a set of words, the search system then compares it with the words occurring in the different documents and can thus identify the documents in which all the given words occur. These documents are thus identified as being relevant. A well known example of search systems are Internet search engines.

Within the group of summarization systems, the goal of available prior art systems is to create a summary of the contents of one or more given documents. In general these systems attempt to identify the most significant sentences of each given document, and the prior art then combines these sentences into a summary of the document(s).

A bulk of prior art systems lie within the field of knowledge mining and knowledge extraction. In general, the goal of such efforts is to convert unstructured text documents into structured knowledge, thus enabling a computer to read the documents and understand the knowledge described within. While some prior art focuses on building complete logical structures of the all the knowledge in a text, others attempt extract units of information, e.g. references to people, places, dates, etc.

Generally, the prior art systems available suffer from the disadvantage that while they aid a user to identify relevant documents or extract knowledge from documents, they do not focus on helping a user to analyze and obtain relevant knowledge from a set of documents.

### DESCRIPTION OF THE INVENTION

It is hence an object of preferred embodiments of the present invention to provide a method which allows for improved post-retrieval processing of document sources. It is a further object of preferred embodiments of the invention to provide a method, which allows for convenient handling a large amounts of document sources to facilitate a human's processing thereof to extract relevant parts of the document sources. It is a further object of preferred embodiments of the invention to provide a method, in which a user is alleviated of the burden of inputting synonyms and hyponyms of a given concept in order to include those in his processing of document sources.

In a first aspect, the invention provides a method of processing a collection of a number of document sources in a computer system to retrieve a number of relevant substrings from said document sources, whereby each relevant substring has relevance with respect to at least one set of selection parameters, the method being characterized by the further steps of:
splitting each document source of the collection of document sources into a plurality of source substrings, whereby each source substring comprises at least two concepts; said plurality of source substrings including at least said relevant substrings;
storing the plurality of source substrings;
uniquely identifying said relevant substrings among said source substrings.

It will be appreciated that the present method at least differs from the available prior art methods in that it performs a splitting of each document source into a plurality of source substrings, each substring containing at least two concepts, e.g. at least two words, a sentence or part thereof or a like set of information- or knowledge-carrying data. Whereas prior art systems identify entire documents based on the individual occurrences of words in the documents, the present method identifies substrings containing a plurality of concepts, with a reference from each substring to one or more source documents. This allows a user of the present method to easily identify specific relevant knowledge within the documents rather than the documents themselves.

For example, a document of several hundred pages may contain two user-specified keywords; one on page 1 of the document, and another one on page 200. In a prior art method, such a document is found relevant, as it contains those two keywords specified by the user of the method, even though the keywords are not related in the document. As opposed to this, the present method only identifies specific substrings of a document source if, in those substrings, knowledge is described involving the two keywords. Thus, the user of the present method is brought directly to the relevant knowledge within the documents rather than being given a reference to an entire document; this in turn allows the user to read only what is significant and relevant, instead of the entire text.

As the user is presented to relevant substrings rather than entire documents, those relevant substrings are presented outside the context of the entire document (where it would normally be seen according to prior art), but within the context of the set of selection parameters. This may result in a higher level of comprehension and better ability to relate to the knowledge in the substrings, as the user's mind is not as tired as when reading the entire text and further, as the mind has not been preconditioned into the patterns and frame of view generated by the context of the entire text. Thus, a user may be able to more clearly see aspects of the knowledge in a substring, which lie outside the context of the entire text surrounding that substring.

According to the Merriam-Webster Online Dictionary (http://www.m-w.com), a concept is 1: something conceived in the mind; thought, notion. 2: an abstract or generic idea generalized from particular instances.

The fact that each substring contains at least two concepts implies that each substring contains knowledge involving the at least two concepts, as the concepts appear in a semantic relation in the substring. Thus, the present method regards the document source in its entirety as a collection of knowledge-carrying substrings. Each of these substrings is in itself potentially relevant to a user of the method. Based on the above definition of a concept, a substring can thus contain two concepts by containing two words used to name concepts.

Each substring may include a predefined number of concepts or words, a predefined number of characters or digits. Alternatively, the method may comprise a step of determining individual lengths of the individual substrings. For example, each substring may consist of a sentence of variable length.

In the step of storing, each substring is stored in a conventional database. Each substring may e.g. include reference to an individual document and reference to the at least two concepts in that substring.

In embodiments of the present invention, the selection parameters can be based on individual keywords, groups of keywords, concepts, groups of concept, meta data criteria, and other parameters. A selection parameter can thus specify, e.g. that a substring must contain a given keyword or concept in order to match the selection parameter; it could also specify that the substring must contain at least one or a group of keywords or concepts (or, alternatively, none of the concepts in a group). Similarly, a selection parameter can specify that a substring must be from a specific part of the document source in order to match the parameter (e.g. the substring must be part of a claim in a patent document). Likewise, a selection parameter could specify that a substring must come from a document source which is e.g. authored by a specific entity. Thus, selection parameters specify some criteria which must be met by a given substring for that substring to match the selection parameter.

Several selection parameters can be joined into a set of selection parameters; in this case, the set also includes specifications of how the selection parameters are joined, i.e. how they interact. For example, in a given set of selection parameters it may be specified that a substring must match either one or another of two specific selection parameters while simultaneously matching all the other selection parameters in the set. This allows for improved flexibility when defining the sets of selection parameters.

In one embodiment of the method of the invention, the at least one set of selection parameters is comprised in a plurality of sets of selection parameters, and the step of identifying comprises identification of a separate group of relevant substrings for each of the sets of selection parameters, whereby a plurality of separate groups of substrings is identified, each of the identified relevant substrings occurring in at least one of the separate groups.

It is thereby achieved that a user of the method of the present invention can specify multiple sets of selection parameters, thus generating multiple groups of relevant substrings. By identifying multiple groups of relevant substrings at the same time, the user avoids having to continuously create new sets of selection parameters, analyze the substrings identified by those parameters, and then changing the selection parameters; instead, several sets of selection parameters can be defined simultaneously, increasing the usability of implementations of the method and improving the user experience of using the method.

At the same time, each of these groups of relevant substrings is related to a given set of selection parameters, these selection parameters thus providing a common denominator for the group. The selection parameters thus serve to “label” the relevant substrings in the group and giving them a context by which they can be identified. This labeling of the groups of substrings enables a user of the method to more quickly comprehend and relate to the substrings of a given group, without having to read the entire text surrounding the individual substrings in the group.

As each relevant substring can occur in one or more separate groups, it is possible to define the sets of selection parameters such that they overlap, i.e. such that two or more sets of selection parameters contain one or more of the same substrings. This means that a user of the method can access the same knowledge via several different sets of selection parameters, and thus with several different contexts. This helps the user of the method to see a given substring in several contexts, thus aiding the user in fully comprehending the import and aspects of the knowledge in the substrings. Seeing substrings outside the original contexts helps the user to understand the knowledge, and relate it to existing relevant knowledge. Furthermore, as substrings can occur in several groups, this gives the user an overview of how the substrings and groups of substrings are related to one another. This results in a higher level of comprehension and thus a better analysis of the document sources.

In one embodiment, the method of the present invention comprises the step of defining at least one combination of sets of selection parameters, and the step of identifying comprises identification of a separate group of relevant substrings for each of the defined combinations of sets of selection parameters.

It is thereby achieved, that a user of the method of the present invention can combine sets of selection parameters to correlate groups of relevant substrings, thus generating a new group of substrings derived from the correlated groups of substrings. This enables a user of the method to precisely specify which substrings should be in the resulting group, by specifying highly specific selection parameters—without having to read the individual substrings.

By enabling a user of the method to create combinations of existing sets of selection parameters, preferred embodiments of the method of the present invention provides the user with an intuitive, simple, and easy way to define highly specific sets of selection parameters. This makes it easier for a user of the method to utilize the advanced capabilities of the selection parameters to specify very precisely the relevant groups of substrings.

As a user of the method can specify group of relevant strings more precisely, the number of relevant substrings to read manually can be decreased, thus enabling the user to analyze the documents sources faster.

Further, by correlating two or more groups of relevant substrings by combining the corresponding sets of selection parameters, it is possible to see how the two or more groups overlap. It is thereby possible to see how the groups of substrings interact, i.e. how which substrings of the groups co-occur in both groups and how these relate to the substrings which do not co-occur. This enables a user of the method to gain an overview of the interrelations in the knowledge in the groups of substrings, and thus in the document sources, thus providing a overview of the (relevant) knowledge in the document sources. This further aids a user in analyzing the knowledge in the document sources.

When combining two or more sets of selection parameters, a new set of selection parameters is defined. In this new set, the individual selection parameters of the combined sets can interact in various ways—just as when defining a set of selection parameters. This enables the method of the present invention to utilize sophisticated sets of selection parameters in the identification of relevant substrings, thus enabling users of the method to very precisely define the criteria which a given substring must match in order to be relevant.

In an embodiment of the method of the present invention the step of defining sets of selection parameters comprises definition of at least two sets of selection parameters. In such an embodiment, the method further comprises displaying, in a display of the computer system, a representation of the at least two sets of selection parameters as row and column headers in a matrix, whereby each cell in the matrix represents a specific combination of the sets of selection parameters represented by that cell's column and row headers. Further, in the present embodiment, the step of identifying comprises identification of a separate group of relevant substrings identified by said specific combination of sets of selection parameters for each cell in the matrix, the step of displaying further comprising displaying, in each cell of the matrix, information representing the separate group of relevant substrings identified by said specific combination of sets of selection parameters.

By displaying a representation of the sets of selection parameters as row and column headers in a matrix it is achieved, that a user of the method of the present invention is presented to a visualization of the sets of selection parameters, enabling an easy overview of these sets. With this overview, a user of the method can thus more easily interact with and manipulate the sets of selection parameters, thus increasing usability of the method.

By letting each cell in the matrix be defined by the combinations of the sets of selection parameters for that cell's row and column headers, a user of the method of the present invention is able to interact with the sets of selection parameters and specify combinations of these in a simple, visual, and intuitive way, by simply moving the sets of selection parameters around in the row and column headers of the matrix. This makes it easier for a user of the method to generate advanced combinations of sets of selection parameters, as they can be specified visually and without going through the individual select parameters of the sets. This vastly improves usability of the method of the present invention, and aids the user to create sophisticated combinations of sets of selection parameters.

Furthermore, by displaying, in each cell of the matrix, information representing the corresponding group of relevant substrings, a user of the method is provided with an overview of the groups of relevant substrings. This way, the user can quickly analyze and see the results of manipulating sets of selection parameters, without going into the individual groups of relevant substrings. This aids a user to more quickly define the optimal set of selection parameters, thus enabling faster analysis of the document sources. Furthermore, a user of the method is provided with an intuitive way to select groups of relevant substrings.

In one embodiment of the present invention the method further comprises, subsequent to the step of identifying, the step of reducing the number of substrings in at least one of the groups of substrings represented in the cells of the matrix by matching the substrings in said at least one group to at least one further selection parameter to thereby filter the substrings of said at least one group.

It is thereby achieved, that a user of the method can filter the relevant substrings in one or more groups of relevant substrings according to the same selection parameter, thus providing the user a method by which the number of substrings in the groups can be reduced according to the same parameter.

If a user is analyzing a collection of patent documents with the present method, the user can use this ability to, for example, filter out all substrings which are not a part of the claims of the patent documents. Thus, the user can quickly gain an overview of which groups of relevant substrings contain part of the claims and thus quickly analyze the claims of the patent documents.

It is further achieved, that a user of the method can supply a further selection parameter which all substrings in one or more groups of substrings must match in order to belong to the group. This enables the user to, for example, filter out substrings which do not match a given concept or substrings which do not belong to a document source which contains a given concept. This enables users to filter undesired substrings, thus focusing on the relevant substrings, enabling the user to more quickly obtain the desired knowledge and complete the analysis.

Another embodiment of the method of the present invention further comprises the step of augmenting at least one of said sets of selection parameters with further selection parameters derived from concepts from a predefined first concept hierarchy.

By augmenting the selection parameters with further parameters derived from a concept hierarchy, the method of the present invention can automatically assist the user with knowledge described in the concept hierarchy. This can take the form of expanding the coverage of sets of selection parameters, by adding parameters which match more relevant substrings.

For example, a user may create a selection parameter based on a given concept, e.g. “lactic acid”. The method of the present invention can automatically augment this with selection parameters based on e.g. the concepts “lactate” and “enterolactone”, as these are a synonym and hyponym, respectively, of “lactic acid”. Thus, the method can also identify relevant substrings based on these two new selection parameters, as well as the original one. In this way, the user does not have to remember (and type in) all the relevant synonyms and hyponyms of a given concept in order to include those in the selection parameters; this greatly increases usability of the method and enables users to more accurately identify all relevant knowledge, thus making the analysis more precise.

By augmenting the selection parameters, it is further achieved that the method of the present invention can handle source documents in several languages. For example, while adding selection parameters based hyponyms and synonyms in a given language, the method can also automatically add synonyms and hyponyms from other languages. This enables the method of the present invention to automatically identify relevant substrings across document sources in different languages—providing a user of the method with a unified overview of and entry to the relevant substrings in all the languages.

By augmenting selection parameters, a user of the method of the present invention experiences better coverage and higher precision as more substrings, which are all relevant, are identified. This, in turn, increases the user's ability to correctly analyze the source documents and also increases the user's sense of security regarding using the method of the present invention.

In one embodiment, the method of the present invention comprises, at said step of identifying, a filtering of the substrings is performed, so as to identify only substrings, which match further selection parameters derived from a second predefined concept hierarchy.

It is thereby achieved, that the number of identified relevant substrings is reduced to include only those with concepts within the second concept hierarchy; this means, that the second concept hierarchy can be used to define, for example, an area of interest for an analysis and the identified relevant substrings will all be within this area of interest. Thus, a user of the method of the present invention can be presented only the substrings which contain knowledge relevant to the area of interest. This increases the relevance of the identified substrings and decreases their number, resulting in faster analysis.

In an embodiment of the present invention, at least one of the first and second concept hierarchy forms part of a main concept hierarchy.

By the second concept hierarchy forming part of a main concept hierarchy it is achieved, that less processing power is required to apply the second concept hierarchy to the identification of relevant substrings, as this can be done as an integral part of the step of splitting the document sources into substrings; in this way, the second concept hierarchy does not have to be applied by itself separately.

By including the first concept hierarchy into a main concept hierarchy it is achieved, that less processing power is required to utilize the first concept hierarchy, as it can be applied directly at the definition of selection parameters, rather then having to be brought in separately.

In one embodiment of the method of the present invention, said sets of selection parameters are augmented by a set of selection parameters representing predefined semantic relations, which describe possible semantic connections between concepts in the substrings.

By deriving a set of selection parameters from the predefined semantic relations, this set of selection parameters can be used in the method to reduce the number of identified relevant substrings, such that the substrings which are identified describe a semantically valid representation of knowledge between two or more concepts in the substring. For a user of the method, this means that the identified relevant substrings all describe some knowledge which is semantically valid, i.e. which contain sensical relations between concepts. This means that there are fewer relevant substrings which carry a higher level of knowledge, enabling a user of the method to more quickly complete the analysis.

One embodiment of the present invention further comprises, prior to the step of identifying, the step of processing said substrings to determine possible combinations of sets of selection parameters, which match significant groups of substrings.

It is thereby achieved, that the method of the present invention automatically suggests sets of selection parameters which identify groups of substrings which are significant in relation to the entire collection of document sources. A user of the method is therefore presented with sets of selection parameters giving an overview of the significant groups of substrings in the document sources, thus providing a simple and intuitive starting point for the analysis. This further aids a user of the method in defining other sets of selection parameters and thus more specifically identifying the groups of relevant substrings.

It is further achieved by the method, that it can help a user to identify and recognize knowledge which might otherwise have been missed. This is achieved as the method automatically suggests sets of selection parameters which correspond to significant groups of substrings—groups which the users might not have discovered without the input of the method.

In a second aspect, the present invention provides a method of processing a collection of a number of document sources in a computer system to display a number of relevant substrings from said document sources, whereby each relevant substring has relevance matching at least one set of selection parameters, the method being characterized by the steps of:
splitting each document source of the collection of document sources into a plurality of source substrings, whereby each source substring comprises at least two concepts; said plurality of substrings including at least said relevant substrings;
storing the plurality of source substrings;
creating a reference between said source substrings and said source documents;
receiving at least two sets of selection parameters from the user;
optionally, expanding said sets of selection parameters with further selection parameters based on a concept hierarchy;
identifying sets of relevant substrings matching said sets of selection parameters;
displaying, e.g. in a matrix or table, representations of said sets of relevant substrings and of the set of relevant substrings defined by the combination of said sets of relevant substrings;
optionally, receiving one or more further sets of selection parameters from the user, identifying a further set of relevant substrings with respect to each of these further sets of selection parameters, and displaying in said table or matrix a representation of each of these further sets of relevant substrings and the sets of relevant substrings defined by the combination of these further sets of relevant substrings with said set of relevant substrings;
enabling the user to select a representation of a set of relevant substrings from said matrix;
providing a list of the relevant substrings corresponding to said selected representation.

It will be appreciated that the method of the second aspect of the invention may constitute an embodiment of and/or be included in the method of the first aspect of the invention. Hence, the description of the method of the first aspect of the invention and embodiments thereof also applies to embodiments of the method of the second aspect of the invention. Likewise, the features and embodiments of the method of the second aspect of the invention may be included in embodiments of the method of the first aspect of the invention.

The method of the second aspect of the invention may enable user to attach a note to one or more of the relevant substrings of said list. Those of the relevant substrings, which the user has seen, may be automatically marked. A list of the attached notes and the relevant substrings to which they were attached may be provided.

A list of the document sources of a set of substrings may be provided.

The at least one set of selection parameters may be comprised in a plurality of sets of selection parameters, and the step of identifying may comprise identification of a separate group of relevant substrings for each of the sets of selection parameters, whereby a plurality of separate groups of substrings is identified, each of the identified relevant substrings occurring in at least one of the separate groups. At least one combination of sets of selection parameters may be defined, and the step of identifying may comprise identification of a separate group of relevant substrings for each of the defined combinations of sets of selection parameters. The step of defining the at least one combination of sets of selection parameters may comprise definition of at least two sets of selection parameters, and the method may further comprise displaying, in a display of the computer system, a representation of the at least two sets of selection parameters as row and column headers in a matrix, whereby each cell in the matrix represents a specific combination of the sets of selection parameters represented by that cell's column and row headers. The step of identifying, may comprise identification of a separate group of relevant substrings identified by said specific combination of sets of selection parameters for each cell in the matrix, and the step of displaying may further comprise displaying, in each cell of the matrix, information representing the separate group of relevant substrings identified by the specific combination of sets of selection parameters.

Subsequent to the step of identifying sets of relevant substrings, the present method may comprise the step of reducing the number of substrings in at least one of the groups of substrings represented in the cells of the matrix by matching the substrings in said at least one group to at least one further selection parameter to thereby filter the substrings of the at least one group.

At least one of the sets of selection parameters may be augmented with further selection parameters derived from concepts from a predefined first concept hierarchy.

At the step of identifying relevant substrings, a filtering of the substrings may be performed, so as to identify only substrings, which match further selection parameters derived from a second predefined concept hierarchy. At least one of the first and second concept hierarchy may form part of a main concept hierarchy.

The sets of selection parameters may be augmented by a set of selection parameters representing predefined semantic relations, which describe possible semantic connections between concepts in the substrings.

Prior to the step of identifying sets of relevant substrings, the present method may comprise the step of processing the substrings to determine possible combinations of sets of selection parameters, which match significant sets of substrings.

Semantic based means may be used to match the relevant substrings with said selection parameters.

The present invention also provides computer programs and/or computer program products comprising means for carrying out the claimed methods.

The present invention additionally provides computer systems comprising at least one processor and a memory, said memory being loaded with a computer program for causing the processor to perform any one of the claimed methods.

### DETAILED DESCRIPTION OF EMBODIMENTS OF THE INVENTION

Various examples of embodiments of the first and second aspects of the invention will now be described with reference to the accompanying drawings, in which:

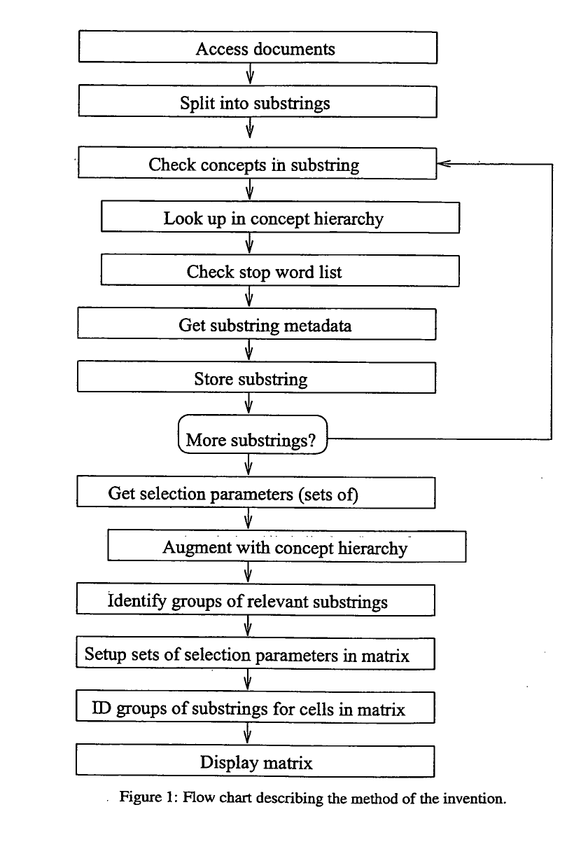

FIG. 1 depicts a flow chart representing the method of the invention.

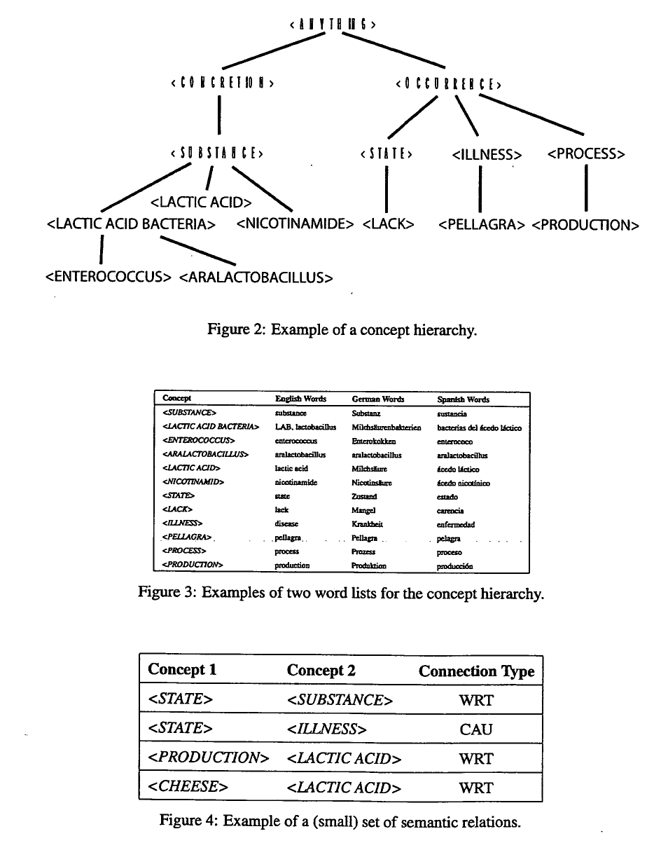

FIG. 2 shows an example of a concept hierarchy that can be used by the present method.

FIG. 3 gives an example of the concept hierarchy's word lists for two different languages.

FIG. 4. gives an example of a set of semantic relations used by certain embodiments of the method.

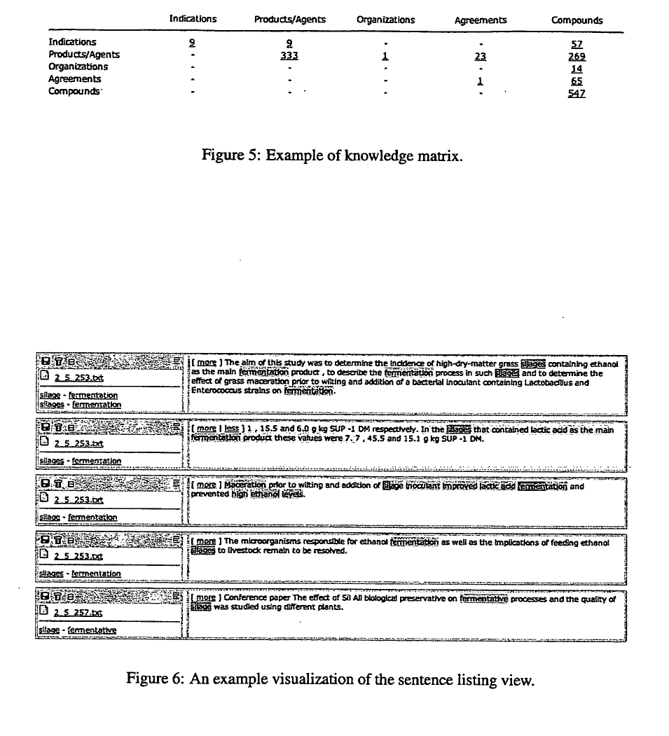

FIG. 5 shows an example of the matrix view and how a two-dimensional fact space matrix could be visualized used the methods of the present invention.

FIG. 6 gives an example visualization of the sentence listing view, as generated by the method of the invention.

To illustrate an embodiment of the present invention, the following simple examples are given.

The examples are based on short documents containing the following text:

Document A: Lack of nicotinamide causes pellagra. Nicotinamide is produced in the liver.

Document B: LAB is used in the production of lactic acid. Lactic acid is an ingredient in the production of several types of cheese. Not all people have the enzymes required to break down lactic acid.

Preferred embodiments of the present invention access and read the documents from a source, for example, a file in a computer. Reading the documents can be achieved in many ways, and a person skilled in the arts can implement one or more of these as part of the embodiment of the present invention. The documents can be accessed one at a time or simultaneously.

Once the embodiment of the method has accessed a document, and its contents are available the method goes on to split the document into substrings, each containing at least two concepts. This can be achieved in many ways, and in one embodiment it is achieved by splitting the text of the document into strings according to sentences delimiters, e.g. full stop, comma, colon, and others. Thus, every time a sentence delimiter is encountered the string read until that point is turned into a separate substring, and the implementation continues from that point to look for the next occurrence of a delimiter. In the present example, the table below illustrates how the documents of the example are split into substrings (the substrings have been numbered with roman numerals and a reference to the document in which it was found):

| ID | Document | Substring |
|---|---|---|
| i | A | Lack of nicotinamide causes pellagra. |
| ii | A | Nicotinamide is produced in the liver. |
| iii | B | LAB is used in the production of lactic acid. |
| iv | B | Lactic acid is an ingredient in the production of |
| | | several types of cheese. |
| v | B | Not all people have the enzymes required to break |
| | | down lactic acid. |

Other embodiments of the present invention use other methods to split documents into substrings.

To identify substrings with at least two concepts, one embodiment of the present invention utilizes a predefined list of stop words, to which the words of the substrings are matched. This may be achieved by first splitting a substring into individual words, using a blank space as delimiter. Each word may then be matched with the words in the predefined list, and if the word does not occur in the list, it is marked as a concept. In this way, the number of concepts in a substring may be counted, and a substring may be checked for whether it contains two or more concepts.

For example, if a predefined list of stop words containing the words of, is, in, the, an is used, the words nicotinamide, produced, and liver are marked as concepts in substring ii. Substring ii thus contains 3 concepts and is thus considered a valid substring.

In another embodiment of the present invention, a concept hierarchy is used instead of the predefined list of words. In this embodiment, a substring may also be divided into individual words by splitting the substring at each blank space. The individual words are then checked with the word lists of the concept hierarchy, and if a concept exists in the concept hierarchy for the word, the word is marked as a concept. The number of concepts in a substring may then be counted in a similar manner. In yet another embodiment, both a concept hierarchy and a predefined list of stop words are used.

FIG. 2 shows an example of a concept hierarchy, which can be used by the embodiment, and FIG. 3 shows examples of the concept hierarchy's word lists in English and Danish. Thus, given substring iii of the above example, the words of the substring may be looked up in the word lists, resulting in the concepts <LACTIC ACID BACTERIA>, <PRODUCTION>, and <LACTIC ACID> (the greater than and less than symbols are used to signify concepts). The word used of the sentence is not in the word lists of the concept hierarchy or in the list of stop words from above; this word may thus be considered to be a possible concept.

In a preferred embodiment of the present invention, if a substring contains only a single concept it is appended to the previous substring; if it contains no concepts, the substring is ignored.

In a preferred embodiment of the present invention, each substring is subsequently stored using a storage mechanism, e.g. a database system. In this database, information about the documents is stored, e.g. title, author, date, etc. Furthermore, each of the substrings may be stored with reference to the document in which it was found and the sequence number of the substring in the document. Further, each of the words of the substring, their sequence numbers in the substring, and any concepts identified for the word may be stored. Optionally, any available meta data for the documents and substrings may be stored.

Each type of data may be stored in a separate table (relation), and maintains references between records in the tables using identifiers for each record. By application of conventional database techniques, a database scheme can be created which is able to store the above mentioned data based on the given description.

A preferred embodiment of the method of the present invention enables the sets of selection parameters of the method to be defined in various ways. Two types of selection parameters may be defined, one being based on words and another being based on a specification of meta data.

A word based selection parameter consists of one or more words, which are stored as part of the selection parameter. In preferred embodiments of the invention, a user can specify the words for a given selection parameter. An example of a word based selection parameter contains the words lactic acid and lactic acid bacteria:

| | |
|---|---|
| 1 | lactic acid, lactic acid bacteria |

This selection parameter is interpreted by as matching all substrings which contain either the word lactic acid or the word lactic acid bacteria.

A selection parameter based on meta data defines one or more pairs of meta data types and values for the given type. Such a selection parameter could, for example, specify all substrings from the abstract or introduction of a document:

| | |
|---|---|
| 2 | Type: substring-from - Value: abstract, introduction |

In preferred embodiments, the possible meta data types are defined based on the meta data available for the substrings or documents stored previously.

In preferred embodiments of the invention, a selection parameter can be negated, meaning that the selection parameter is utilized oppositely to how it is defined. Thus, if the word based selection parameter 1 exemplified above is negated, the negated selection parameter would be interpreted as “substrings which do not contain the words lactic acid and lactic acid bacteria”.

In preferred embodiments of the invention, a selection parameter can be designated to apply to an individual substring or to the entire document in which a substring was found. In this way, for example, meta data based selection parameters may be applied to the document for document type meta data (publication date, title, author, etc) as well as to substrings for substring types of meta data, e.g. where the substrings comes from (header, abstract, reference list, etc), whether it is a headline, and so on.

To generate a set of selection parameters, one preferred embodiment enables several selection parameters to be joined into a set of selection parameters. Per default, the individual selection parameters are be joined into a set in which they all have equal standing, i.e. where all selection parameters are utilized in the same way; however, individual relations between selection parameters may also be specified.

This enables a set of selection parameter to specify, using the examples from above, that a substring must be from the introduction or abstract and contain either of the words lactic acid or lactic acid bacteria:

| | |
|---|---|
| 1 | lactic acid, lactic acid bacteria |
| 2 | Type: substring-from - Value: abstract, introduction |

An embodiment of the present invention further allows assigning weights to each selection parameter in the set, thus specifying the importance of each selection parameter. A given selection parameter can thus be rated as more important by giving it a higher weight than another selection parameter.

In a preferred embodiment of the present invention two or more sets of selection parameters can be combined to form a new set of selection parameters. This may be achieved by creating a new set of selection parameters and then joining it with each selection parameter from the sets being combined.

A preferred embodiment of the invention allows specification of how the sets of selection parameters should be combined, and this is implemented using the negation of selection parameters, relations between selection parameters, and weights on selection parameters.

A preferred embodiment of the present invention allows a user of the embodiment to define labels for selection parameters and sets of selection parameters and combinations hereof. This is done by obtaining the label as a string from the user, and storing this string along with the (sets of) selection parameters. A simple input form is used to obtain the string from the user and the label is then used to represent the (set of) selection parameters to the user. If a label is not given, the embodiment automatically defines a label based on the first word of word based selection parameter or the type and value of a meta data based selection parameter. For example, the selection parameter 1 could be given the label “LAB”.

In a preferred embodiment of the invention, a concept hierarchy is used to augment a set of selection parameters with further selection parameters which are derived from the concept hierarchy; this is achieved without user input. The concept hierarchy may be utilized to expand word based selection parameters with words which have the same meaning (i.e. synonyms) and words which describe more specific concepts (i.e. hyponyms).

For example, given a word selection parameter comprising the word “LAB”, this word may be looked up in the concept hierarchy and find the concept with the name <LACTIC ACID BACTERIA> (the less than and greater then symbols are used to signify a concept). Other words for the same concept may then be looked up and the words “LAB” and “lactobacillus” found; these are then added to the selection parameter. Further, the words for more specific concepts for the concept <LACTIC ACID BACTERIA> may be looked up; looking at the concept hierarchy in FIG. 2 and the word lists in FIG. 3, the two words “aralactobacillus” and “enterococcus” are found. A new selection parameter is created with these two further words and the new selection parameter is added to the set. In this way, the selection parameters may be expanded with relevant words—both synonyms and hyponyms—and a user of the embodiment is released of the burden of memorizing or inputting all these words.

In another embodiment of the invention, the concept hierarchy is further utilized to augment word based selection parameters with words in other languages. This is achieved similarly to the above augmentation with synonyms and hyponyms, except here the concept hierarchy's word lists in other languages may be used. Continuing the previous example, the word from the selection parameter may be looked up in the concept hierarchy to find the concept <LACTIC ACID BACTERIA>. However, instead of looking for other words for the concept and more specific concepts in the English word list of the concept hierarchy, the word lists in other languages may be searched. Thus, for example, the word “Milchsäurenbakterien” and “bacterias del ácedo láctico” may be found in the German and Spanish word lists of the concept hierarchy, respectively, and new selection parameters based on these words may be created.

In the method of the present invention, the sets of selection parameters are used to identify groups of relevant substrings. Thus, a preferred embodiment of the present invention provides a method for selecting groups of substrings given a set of selection parameters.

All the selection parameters of the set and their weights and internal relationships may be read. Based on this, a set of criteria may be set up which a given substring must match in order to be part of the identified group of substrings. The criteria for selection parameters based on words are relatively simple, as they specify that one of the given word must occur in a substring (or, if negated, must not occur in a substring). If the selection parameter is on the document level, the criteria is that there must exist a substring from a given document which contains (or, conversely, which does not contain) one of the given words in order for any substrings of that document to match the criteria.

The criteria for a selection parameter comprising meta data is similar to those comprising words, except instead of looking at the words of a substring or document, the meta data types and values of a given substring or document is analyzed. If a substring is to match the criteria, its meta data must match the type and values specified in the selection parameter.

| | |
|---|---|
| 1 | lactic acid, lactic acid bacteria |
| 2 | Type: substring-from - Value: abstract, introduction |

For example, the selection parameters 1 and 2 repeated above may be interpreted to the following criteria:
1. Identify substrings which contain either of the words lactic acid or lactic acid bacteria.
2. Identify substrings which have attached meta data where the meta data type is substring-from and the meta data value is either abstract or introduction.

Once the criteria for the selection parameters have been defined, one embodiment of the present invention goes on to iterating through the database containing the substrings, documents, and meta data. Examining the substrings one by one, the substrings which match the criteria may quickly be identified and these can be selected for the group of relevant substrings.

Depending on the storage mechanism used by to store the substrings, documents, meta data, etc., these criteria can be used more or less directly to identify substrings which match the criteria.

Preferred embodiments of the present invention utilize several indexing and caching methods to optimize the processing requirements and response time for the identification of substrings. In one embodiment of the present invention, an index from criteria to substrings is maintained and utilized. Using this index, a group of substrings which match a given criteria may be obtained, analyzing every substring in the database only once to build the index. In another embodiment, for each criteria a group of substring identifiers is loaded into a set; these sets are then intersected to get the final group of relevant substrings which match all the criteria. Several other optimizations are utilized by embodiments of the present invention; these are not described in further detail here, as a person skilled in the arts is able to recognize and implement them.

A preferred embodiment of the present invention enables the identification of several groups of substrings based on several sets of selection parameters. This is done as described above. A given substring may occur in one or more of these groups, thus enabling overlapping groups of substrings to be identified. The embodiment provides methods for identifying these overlaps and this is done by using set intersection methods (from mathematical set theory). For example, if a substring occurs in both group A and group B, it is part of the overlap of A and B—and it can be identified by intersecting the substrings of group A and the substrings of group B. However, if it occurs in only one of A and B (or none of them), the substring is not part of the overlap and is not identified by the set intersection of A and B. Thus, a user of the embodiment is able to easily compare to groups of substrings and find how much overlap there is between the two, and thereby identify the level of correlation between the two groups. This is useful, for example, for finding the similarity of two groups of substrings.

A preferred embodiment of the present invention provides methods for displaying representations of sets of selection parameters and groups of substrings in a matrix. This matrix may be created by using representations of sets of selection parameters as the values on the dimensions of the matrix; if available, the labels of the sets of selection parameters are utilized. A user of the embodiment can define which sets of selection parameters should be on which dimensions of the matrix, specifying this, for example, by dragging and dropping the representation of a given set of selection parameters to the desired dimension. FIG. 5 gives an example of a matrix with labels for sets of selection parameters as the values on the dimensions of the matrix. If no dimensions are defined for the sets of selection parameters, each set of selection parameters may automatically be assigned to all dimensions of the matrix, resulting in a matrix where all dimensions contains the same values.

Once the dimensions are defined and sets of selection parameters have been assigned to them, combinations of sets of selection parameters for each cell in the matrix may be generated. This is done such that in each cell, a reference to a combination of selection parameters is stored, that specific combination of sets of selection parameters being the combination of the sets of selection parameters which are represented by the cell's values on the dimensions. In a preferred embodiment of the invention, the combinations in the cells of the matrix can be controlled by the user. The user defines how the sets of selection parameters should be combined in the cells by specifying this for the entire matrix; the combinations are then created based on this. Any of the previously described types of combinations of sets of selection parameters are viable, and the combination of the sets of selection parameters is done as described previously.

Once the combinations have been completed, each cell in the matrix is related to a combination of sets of selection parameters. Groups of substrings for each cell may then be identified, utilizing the combinations of sets of selection parameters to identify substrings; this is done as described previously. As identifying groups of substrings is completed, each cell in the matrix is related to the group of substrings identified for that cell, and a representation of the group of substrings may be displayed in the cell of the matrix. An embodiment of the invention can show many representations of a group of substrings in the cells of the matrix, some of these being how many substrings and in the group, how many different sources do the substrings of the group come from, how many substrings have not been shown to the user before, and a reference to the group of substrings.

As a user interacts modifies the matrix, selection parameters, or groups of substrings, the corresponding cells of the matrix may be automatically updated to display the latest status of the matrix.

An example of a displayed matrix is given in FIG. 5. In this figure, only the number of substrings in a group is shown in each cell of the matrix, and labels for the sets of selection parameters are shown as the dimension values in the matrix. As a reference to the group of substrings identified for a given cell in the matrix may be provided, a user can access such a group of substrings by selecting the corresponding cell in the matrix.

A preferred embodiment of the present invention enables a user to apply filters to one or more cells in the matrix, thus constraining the substrings which are in the groups referenced by the cells. In this embodiment, a filter consists of one or more selection parameters, i.e. a set of selection parameters. When applying the filter to a given cell, the selection parameters of the filter are converted into criteria, and each substring in the group referenced by the cell is compared to these criteria. If a substring matches, it is allowed to stay in the group; otherwise it is removed from the group. The generation of criteria from selection parameters and the matching of substrings with the criteria is described previously. When applying a filter to more cells of the matrix, the generated criteria of the filter are applied in turn to the substrings in the groups of substrings referenced by the specified cells, and the process described here is repeated for each group.

In an example usage of the embodiment, a user can use a filter to narrow down the substrings in the groups referenced by the cells of the matrix to contain only substrings from the abstracts of the documents. In this way, only substrings from the abstracts of the documents are in the groups. If the documents are, for example, patent applications, a user can use filters to remove every substring which is not from the claims of the patents—this is desirable for a user who is only interested in analyzing the claims, e.g. in freedom to operate analyses.

As an example, consider the selection parameter 2 which matches only substrings which come from the abstracts or introductions of the documents. Applying this selection parameter as a filter will result in that only the substrings which are not from the introduction or abstract of a document, will be included in the group(s) of identified substrings.

In an embodiment of the present invention, a set of selection parameters is defined based on a second concept hierarchy and this set of selection parameters is used to further constrain the substrings in all identified groups of substrings. This second concept hierarchy can be similar to the first; however, it may be used quite differently. A set of selection parameters comprising all the words of the concepts in the second concept hierarchy may be defined, resulting in large, word based selection parameters joined in a set.

Whenever a group of substrings is identified, membership of the group may further be constrained to be those substrings which further match the criteria generated from the selection parameters derived from the second concept hierarchy. Thus, a substring is only part of a group if is matches these criteria; the matching is done as described previously.

Thus, the identified substrings may be constrained to be those which match with the second concept hierarchy. This is used to apply domain specificity to the identified substrings. For example, if the second concept hierarchy describes the concepts relevant to a given knowledge domain, e.g. enzymes, a user of the embodiment can constrain the identified substrings to only those substrings which are somehow related to enzymes.

As an example, consider the part of the concept hierarchy in FIG. 2 which includes the concepts <SUBSTANCE> and two (of its three) sub-concepts <LACTIC ACID> and <LACTIC ACID BACTERIA>. This part can be considered a separate concept hierarchy which an embodiment of the present invention can use as the second concept hierarchy. The word list shown in FIG. 3 gives us the words LAB, lactobacillus, enterococcus, aralactobacillus, and lactic acid, and these may be used to construct a word based selection parameter. Revisiting the two example documents A and B and utilizing this second hierarchy, the current embodiment of the invention will therefore discard substrings i and ii (i.e. both substrings from document A) as these do not contain any of the concepts in the second concept hierarchy. The substrings are repeated here:

| ID | Document | Substring |
|---|---|---|
| i | A | Lack of nicotinamide causes pellagra. |
| ii | A | Nicotinamide is produced in the liver. |
| iii | B | LAB is used in the production of lactic acid. |
| iv | B | Lactic acid is an ingredient in the production of |
| | | several types of cheese. |
| v | B | Not all people have the enzymes required to break |
| | | down lactic acid. |

An embodiment of the invention enables this second concept hierarchy to be part of the main concept hierarchy, making it simpler for to match the substrings to the criteria, as the substrings have already been matched with the main concept hierarchy (in the step of splitting the documents into sentences) and the filtering according to the second concept hierarchy can occur at a very early stage.

One embodiment of the invention augments sets of selection parameters with further selection parameters based on predefined semantic relations, which define possible relations between concepts in the substrings.

When creating a set of selection parameters, the predefined semantic relations may be examined recognizing the semantic relations which relate words or concepts used in the selection parameters. For each of these identified semantic relations, a further selection parameter may then be added to the set, the new selection parameter being based on the words to which the semantic relation relates the words of the original selection parameter.

In FIG. 4 is given an example of semantic relations for the concept hierarchy shown in FIG. 2. Given the selection parameter 1, the third and fourth semantic relations may thus be identified, as these relations match the concept <LACTIC ACID>, which is instantiated by the word lactic acid from the selection parameter. Based on this, a further word based selection parameter may be created comprising the words production and cheese. This selection parameter, joined with selection parameter 1, results in a set of selection parameters which match substrings iii and iv. Without the semantic relations, the original selection parameters match substrings iii, iv, as well as v. The substrings and selection parameters are repeated below:

| ID | Document | Substring |
|---|---|---|
| i | A | Lack of nicotinamide causes pellagra. |
| ii | A | Nicotinamide is produced in the liver. |
| iii | B | LAB is used in the production of lactic acid. |
| iv | B | Lactic acid is an ingredient in the production of |
| | | several types of cheese. |
| v | B | Not all people have the enzymes required to break |
| | | down lactic acid. |

| | |
|---|---|
| 1 | lactic acid, lactic acid bacteria |
| 2 | Type: substring-from - Value: abstract, introduction |

One embodiment of the invention utilizes the semantic relations when generating combinations of sets of selection parameters. When combining sets of selection parameters, the semantic relations which define relations between words in selection parameters from different sets may be found. Examining these relations, all the word based selection parameters which are not related by a semantic relation may then be discarded. In this way, all the word based selection parameters, for which there does not exist a semantic relation across the sets of selection parameters may be discarded. Thus, the substrings identified for the combination of sets of selection parameters are only those substrings in which a semantic relation defines a possible relation between the words (concepts) in the substring and where those words also match at least one selection parameter from each original set of selection parameters.

Regarding again FIG. 4 with examples of semantic relations for the concept hierarchy shown in FIG. 2. Let us consider a set of word based selection parameters comprising the words cheese and pellagra, i.e. 3 and 4 respectively:

| | |
|---|---|
| 1 | lactic acid, lactic acid bacteria |
| 2 | Type: substring-from - Value: abstract, introduction |
| 3 | cheese |
| 4 | pellagra |

Given the selection parameters 1 and the set of 3 and 4, the fourth semantic relation may thus be identified, as this relation matches the concepts <LACTIC ACID> and <CHEESE>, which are instantiated by the words from the selection parameters 1 and 3. However, there are no semantic relations relating selection parameter 4 to any of the others; this selection parameter may thus be discarded, resulting in a combination of selection parameters 1 and 3, and the substring iii (as repeated below) may thus be identified.

| | |
|---|---|
| iii | LAB is used in the production of lactic acid. |

A preferred embodiment of the present invention includes functions to automatically generate sets of selection parameters which identify groups of substrings. Word based selection parameters may be generated, by evaluating the significance of all the words used in the substrings and then selecting a number of the most significant words. The numbers of selection parameters generated can be specified by a user, based on a minimum significance value, or a predefined number.

To calculate the significance of a given word in relation to all substrings, one embodiment utilizes significance measures commonly known from the fields of information retrieval and search systems. One embodiment uses an adapted form of the TF*IDF measure, which is focused on individual words rather than documents. This measure is well known and described in several sources, among these “Modern Information Retrieval”, Ricardo Baeza-Yates and Berthier Ribeiro-Neto, Addison Wesley, ACM Press 1999.

When calculating the significance of a word in relation to all substrings, another embodiment of the invention utilizes the concept hierarchy to calculate the specificity of the word's concept(s) in the concept hierarchy. The concept specificity is calculated as the number of steps to the top of the concept hierarchy (i.e. the number of more general concepts) divided by the number of more specific concepts. The concept specificity gives a value for how specific a given concept in the concept hierarchy is; the higher this value, the more specific the concept.

As an example, consider the concept hierarchy in FIG. 2; from the concept hierarchy the specificity of the concepts <NICONTINAMIDE> (S1) and <LACTIC ACID BACTERIA> (S2) can be found using the formulas:

S1=(no. parents+1)/(no. subsumees+1)=(3+1)/(0+1)=4

S2=(no. parents+1)/(no. subsumees+1)=(3+1)/(2+1)

Another embodiment of the invention utilizes both the TF*IDF value and the concept specificity to identify the concepts for which to automatically generate selection parameters.

1. A method of processing a collection of a number of document sources in a computer system to retrieve a number of relevant substrings from said document sources, whereby each relevant substring has relevance with respect to at least one set of selection parameters, the method being characterized by the further steps of:
splitting each document source of the collection of document sources into a plurality of source substrings, whereby each source substring comprises at least two concepts; said plurality of source substrings including at least said relevant substrings;
storing the plurality of source substrings;
uniquely identifying said relevant substrings among said source substrings.

2. A method according to claim 1, wherein said at least one set of selection parameters is comprised in a plurality of sets of selection parameters, and wherein the step of identifying comprises identification of a separate group of relevant substrings for each of the sets of selection parameters, whereby a plurality of separate groups of substrings is identified, each of the identified relevant substrings occurring in at least one of the separate groups.

3. A method according to claim 2, comprising the step of defining at least one combination of sets of selection parameters, and wherein the step of identifying comprises identification of a separate group of relevant substrings for each of the defined combinations of sets of selection parameters.

4. A method according to claim 3, wherein the step of defining comprises definition of at least two sets of selection parameters, the method further comprising displaying, in a display of the computer system, a representation of the at least two sets of selection parameters as row and column headers in a matrix, whereby each cell in the matrix represents a specific combination of the sets of selection parameters represented by that cell's column and row headers, and wherein the step of identifying comprises identification of a separate group of relevant substrings identified by said specific combination of sets of selection parameters for each cell in the matrix, and wherein the step of displaying further comprises displaying, in each cell of the matrix, information representing the separate group of relevant substrings identified by said specific combination of sets of selection parameters.

5. A method according to claim 4, further comprising, subsequent to the step of identifying, the step of reducing the number of substrings in at least one of the groups of substrings represented in the cells of the matrix by matching the substrings in said at least one group to at least one further selection parameter to thereby filter the substrings of said at least one group.

6. A method according to claim 1, further comprising the step of augmenting at least one of said sets of selection parameters with further selection parameters derived from concepts from a predefined first concept hierarchy.

7. A method according to claim 1, wherein, at said step of identifying, a filtering of the substrings is performed, so as to identify only substrings, which match further selection parameters derived from a second predefined concept hierarchy.

8. A method according to claim 6, wherein at least one of the first and second concept hierarchy forms part of a main concept hierarchy.

9. A method according to claim 1, wherein said sets of selection parameters are augmented by a set of selection parameters representing predefined semantic relations, which describe possible semantic connections between concepts in the substrings.

10. A method according to claim 1, further comprising, prior to the step of identifying, the step of processing said substrings to determine possible combinations of sets of selection parameters, which match significant sets of substrings.

11. A computer program comprising means for carrying out the method of claim 1.

12. A computer system comprising at least one processor and a memory, said memory being loaded with a computer program for causing the processor to perform the method of claim 1.

13. A method of processing a collection of a number of document sources in a computer system to display a number of relevant substrings from said document sources, whereby each relevant substring has relevance matching at least one set of selection parameters, the method being characterized by the steps of:
splitting each document source of the collection of document sources into a plurality of source substrings, whereby each source substring comprises at least two concepts; said plurality of substrings including at least said relevant substrings;
storing the plurality of source substrings;
creating a reference between said source substrings and said source documents;
receiving at least two sets of selection parameters from the user;
optionally, expanding said sets of selection parameters with further selection parameters based on a concept hierarchy;
identifying sets of relevant substrings matching said sets of selection parameters;
displaying, e.g. in a matrix or table, representations of said sets of relevant substrings and of the set of relevant substrings defined by the combination of said sets of relevant substrings;
optionally, receiving one or more further sets of selection parameters from the user, identifying a further set of relevant substrings with respect to each of these further sets of selection parameters, and displaying in said table or matrix a representation of each of these further sets of relevant substrings and the sets of relevant substrings defined by the combination of these further sets of relevant substrings with said set of relevant substrings;
enabling the user to select a representation of a set of relevant substrings from said matrix;
providing a list of the relevant substrings corresponding to said selected representation.

14. A method according to claim 1 characterized by enabling the user to attach a note to one or more of the relevant substrings of said list.

15. A method according to claim 1 characterized by automatically marking which of said relevant substrings the user has seen.

16. A method according to claim 1 characterized by providing a list of said attached notes and the relevant substrings to which they were attached.

17. A method according to claim 1 characterized by providing a list of the document sources of a set of substrings.

18. A method according to claim 13, wherein said at least one set of selection parameters is comprised in a plurality of sets of selection parameters, and wherein the step of identifying comprises identification of a separate group of relevant substrings for each of the sets of selection parameters, whereby a plurality of separate groups of substrings is identified, each of the identified relevant substrings occurring in at least one of the separate groups.

19. A method according to claim 18, comprising the step of defining at least one combination of sets of selection parameters, and wherein the step of identifying comprises identification of a separate group of relevant substrings for each of the defined combinations of sets of selection parameters.

20. A method according to claim 19, wherein the step of defining comprises definition of at least two sets of selection parameters, the method further comprising displaying, in a display of the computer system, a representation of the at least two sets of selection parameters as row and column headers in a matrix, whereby each cell in the matrix represents a specific combination of the sets of selection parameters represented by that cell's column and row headers, and wherein the step of identifying comprises identification of a separate group of relevant substrings identified by said specific combination of sets of selection parameters for each cell in the matrix, and wherein the step of displaying further comprises displaying, in each cell of the matrix, information representing the separate group of relevant substrings identified by said specific combination of sets of selection parameters.

21. A method according to claim 20, further comprising, subsequent to the step of identifying, the step of reducing the number of substrings in at least one of the groups of substrings represented in the cells of the matrix by matching the substrings in said at least one group to at least one further selection parameter to thereby filter the substrings of said at least one group.

22. A method according to claim 1, further comprising the step of augmenting at least one of said sets of selection parameters with further selection parameters derived from concepts from a predefined first concept hierarchy.

23. A method according to claim 1, wherein, at said step of identifying, a filtering of the substrings is performed, so as to identify only substrings, which match further selection parameters derived from a second predefined concept hierarchy.

24. A method according to claim 22, wherein at least one of the first and second concept hierarchy forms part of a main concept hierarchy.

25. A method according to claim 1, wherein said sets of selection parameters are augmented by a set of selection parameters representing predefined semantic relations, which describe possible semantic connections between concepts in the substrings.

26. A method according to claim 1, further comprising, prior to the step of identifying, the step of processing said substrings to determine possible combinations of sets of selection parameters, which match significant sets of substrings.

27. A method according to claim 1 characterized by using semantic based means to match said relevant substrings with said selection parameters.

28. A computer program comprising means for carrying out the method of claim 1.

29. A computer system comprising at least one processor and a memory, said memory being loaded with a computer program for causing the processor to perform the method of claim 1.
